(19) United States
(12) Patent Application Publication
(10) Pub. No.: US 2026/0356231 A1
(43) Pub. Date: Nov. 12, 2026

(54) Charging Device Comprising an Adapter Plug Magazine

(71) Applicant: Bayerische Motoren Werke Aktiengesellschaft, Muenchen (DE)

(72) Inventors: Florian BUETTNER, Pfakofen (DE); Clemens BUSCH, Ismaning (DE)

(21) Appl. No.: 19/120,831

(22) PCT Filed: Aug. 11, 2023
(86) PCT No.: PCT/EP2023/072285

§ 371 Date: Apr. 14, 2025

(30) Foreign Application Priority Data
Oct. 21, 2022 (DE) 10 2022 127 903.0

(51) Int. Cl. B60L 53/65; B60L 53/16; B60L 53/30; B60L 53/31; B60L 53/35

(52) U.S. Cl. CPC B60L 53/65; B60L 53/16; B60L 53/305; B60L 53/31; B60L 53/35

(57) ABSTRACT

A charging device for charging electrically driven vehicles includes a charging interface for coupling the charging device to a charging socket of an electrically driven vehicle, a communication interface for identifying the vehicle, an adapter plug magazine that contains a supply of a plurality of adapter plugs, and a control unit which is connected to the communication interface and the adapter plug magazine for the exchange of information and is designed to control the adapter plug magazine.

### BACKGROUND AND SUMMARY

The invention relates to a charging device for charging electrically powered vehicles carrying loads and/or people.

In the following, the term “vehicle” is used synonymously with the term “electrically powered vehicle”. This also includes “at least partially electrically powered vehicles.”

In order to be ready to drive, electrically powered vehicles must be charged at regular intervals. For this purpose, such a vehicle is usually coupled with a charging device in order to supply the vehicle's batteries with electrical energy and thus charge them. A basic prerequisite for charging vehicles on a charging device is that the charging device and the vehicle have the same charging system, i.e., are compatible with each other. A large number of different charging systems are known from the prior art. The best-known charging systems are Type 1, Type 2 Mennekes, Combined AC/DC Charging System (hereinafter referred to as “CCS”), Type F, Commission on the Rules for the Approval of the Electrical Equipment (hereinafter referred to as “CEE”), Charge de Mode (hereinafter referred to as “ChadeMo”) and the Tesla Supercharger. In addition to the aforementioned charging systems, there are a large number of other charging systems as well as manufacturer-specific features.

Due to the large number of charging systems available on the market, not every vehicle is compatible with every charging device. This considerably restricts the choice of charging devices at which a vehicle can be charged. The search for a suitable charging device for the vehicle is therefore often time-consuming and restricts the mobility and range of the vehicle.

One suggestion to overcome the aforementioned problem is the use of so-called adapter plugs, which establish compatibility between a charging device and an electrically powered vehicle that would otherwise not be compatible with each other. However, such adapter plugs are often limited to creating compatibility between two specific charging systems. This considerably restricts the use of such adapter plugs, as a large number of adapter plugs have to be purchased and carried around.

In this respect, it is the object of the present invention to eliminate the disadvantages of the prior art and to provide a device with which an electrically powered vehicle can be charged in a simple manner.

The object is achieved in accordance with the invention by a charging device for charging electrically driven vehicles carrying loads and/or people, comprising a charging interface for coupling the charging device to a charging socket of an electrically driven vehicle. The charging device has a communication interface for identifying the vehicle, an adapter, an adapter-plug magazine containing a stock of several adapter plugs, and a control unit which is connected to the communication interface and the adapter-plug magazine in an information-exchanging manner and is set up to control the adapter-plug magazine. Each of the plurality of adapter plugs has a first adapter side that is compatible with the charging interface of the charging device and a second adapter side that is compatible with a particular charging system for an electrically powered vehicle. Each of the plurality of adapter plugs has a second adapter side that is different from the other adapter plugs.

The invention is based on the basic idea of providing a large number of different adapter plugs already on the charging device. The charging device according to the invention is thus able to charge vehicles with different charging systems, since the stock of adapter plugs provided in the charging device always keeps an adapter plug compatible with the respective charging system of the vehicle ready. Consequently, there is no need for the user of the charging device to carry a large number of adapter plugs in order to connect his electrically powered vehicle to the respective charging device. The vehicle can be charged easily using the charging device according to the invention without certain charging systems being excluded from charging at the charging device. The adapter plug magazine is controlled by the communication with the vehicle, so that the adapter is immediately available to the user.

According to a first aspect of the invention, the communication interface is set up to query charging system-specific data about a vehicle to be charged and forward it to the control unit, on the basis of which the control unit selects an adapter plug with a second adapter side from the adapter plug magazine that is compatible with the charging system of the vehicle to be charged. This ensures that an adapter plug compatible with the vehicle's charging system is automatically selected from the stock of adapter plugs without a user having to select the appropriate adapter plug. This makes it particularly quick and easy to select the adapter plug.

Charging system-specific data refers to all data that is relevant to the charging process. For example, data about the charging system of the vehicle, data about the charging system of the charging device, data about the charging time and about the charging status of the vehicle.

According to another aspect of the invention, the adapter plug magazine is coupled to an output unit which is set up to release an adapter plug from the adapter plug magazine when the control unit has selected the adapter plug. Advantageously, the adapter plug selected by the control unit can be removed directly from the charging device via the output unit. Theft of other plugs is thus avoided.

According to a variant of the invention, the charging device is designed as an automatic charging device and has a motorized adjustable charging arm, which can be brought into engagement with the output unit and is set up to couple with the first adapter side of the adapter plug after the selection of an adapter plug by the control unit and to effect an automatic transfer of the adapter plug from the output unit into the charging socket of the vehicle to be charged. This allows the vehicle to be electrically coupled to the charging arm and charged via the second adapter side of the adapter plug. This eliminates the need to manually remove the adapter plug from the output unit. Such a charging device is fully automatic and capable of coupling a vehicle to be charged to the charging device and charging it without manual user interaction.

According to another variant, it is provided that the output unit is set up to make the adapter plug selected by the control unit available to a user, so that the user can electrically couple the vehicle to be charged with the charging interface of the charging device via the adapter plug. In the present variant, the charging device is therefore designed to be manual. Such a charging device requires less maintenance and is less susceptible to technical faults or defects.

In a further embodiment, it is provided that the communication interface is designed as a touch display, a WLAN interface, an NFC interface or a Bluetooth interface. If the communication interface is designed as a touch display, it is advantageous that the charging device can be interacted with intuitively and easily. If, on the other hand, the communication interface is designed as a WLAN interface, an NFC interface or a Bluetooth interface, communication between the vehicle and the charging device can take place directly via a user interface in the vehicle.

In a further embodiment, the second adapter side of an adapter plug corresponds to a charging system selected from the group consisting of Type 1, Type 2 Mennekes, CCS, Type F, CEE, ChadeMo and Tesla Supercharger as well as manufacturer-specific features thereof. The aforementioned selection ensures that a large number of charging systems are compatible with the charging device.

The first adapter side is compatible with the charging interface of the charging device and can correspond to one of the above-mentioned charging systems or a charging device-specific feature.

According to a further aspect, the charging device is a stationary charging device, in particular a stationary charging column. The design of the charging device as a stationary charging device or a stationary charging column is particularly advantageous, since known specifications can be used.

According to one variant, the adapter plug magazine can be designed as a rotating drum magazine which has a plurality of radially arranged stores, wherein each store is occupied by one adapter plug of the plurality of adapter plugs. Such an adapter plug magazine can easily store a large number of adapter plugs and, if required, dispense an adapter plug from the stock.

In another variant, the adapter plug magazine can be designed as a circulation system that has multiple levels that rotate about a central axis, wherein each level is occupied by one adapter plug of the plurality of adapter plugs, and wherein the circulation system has a common removal and loading opening for removing and loading the adapter plugs. Such a circulation system is also known as a “paternoster”. Such a system allows a large number of adapter plugs to be easily accommodated, stored and, if required, dispensed via the common removal and loading opening.

Further advantages and features of the invention can be found in the following description and the drawings, to which reference is made.

### BRIEF DESCRIPTION OF THE DRAWINGS

FIG. 1 is a schematic representation of a charging device according to an embodiment of the invention;

FIG. 2 is a schematic representation of an embodiment of an adapter plug magazine designed as a drum magazine, which is used in the invention;

FIG. 3 is a schematic representation of an embodiment of an adapter plug magazine designed as a circulation system, which is used in the invention;

FIG. 4 is a schematic representation of the charging device shown in FIG. 1, which is connected to an electrically powered vehicle via a charging cable; and

FIG. 5 is a schematic representation of the charging device shown in FIG. 1, which is connected to an electrically driven vehicle via a motorized adjustable charging arm.

### DETAILED DESCRIPTION OF THE DRAWINGS

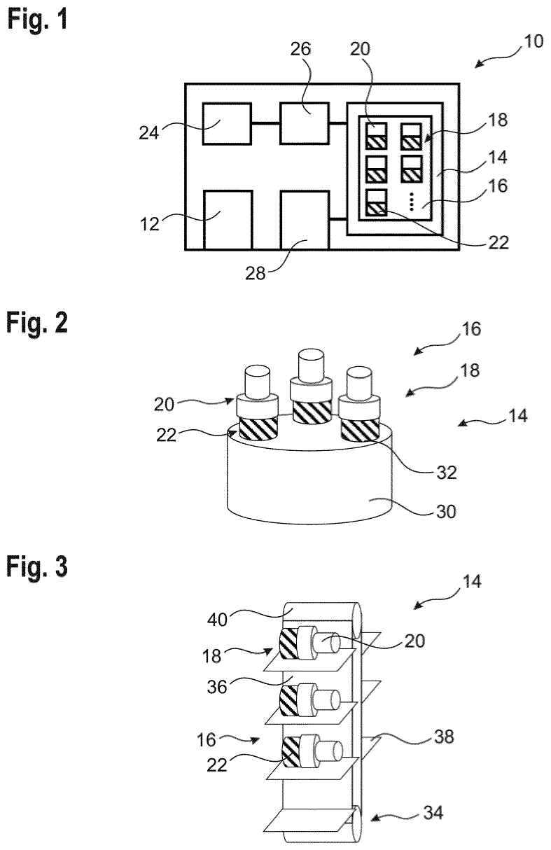

FIG. 1 shows a charging device 10 for charging electrically powered vehicles.

The charging device 10 has a charging interface 12, which is set up to couple the charging device 10 to a charging socket of an electrically powered vehicle.

Furthermore, the charging device 10 has an adapter plug magazine 14 which contains a stock 16 of a plurality of adapter plugs 18. A stock 16 of a plurality of adapter plugs 18 is understood to mean a large number of different adapter plugs 18.

More specifically, each of the plurality of adapter plugs 18 has a first adapter side 20, which is compatible with the charging interface 12 of the charging device 10, and a second adapter side 22, which is compatible with a specific charging system for an electrically powered vehicle. In this case, each of the plurality of adapter plugs 18 has a second adapter side 22 that is different from the other adapter plugs 18. Advantageously, so many adapter plugs 18 are included in the stock 16 that an associated adapter plug 18 with a corresponding second adapter side 22 is present in the stock 16 for each known charging system on the market.

Furthermore, the charging device 10 has a communication interface 24 and a control unit 26, both of which are connected to each other in an information-exchanging manner. The control unit 26 is also connected to the adapter plug magazine 14 in an information-exchanging manner and is set up to control the adapter plug magazine 14.

The communication interface 24 is set up to query charging-system-specific data about a vehicle to be charged and to forward it to the control unit 26, on the basis of which the control unit 26 selects an adapter plug 18 with the second adapter side 22 from the adapter plug magazine 14, which is compatible with the charging system of the vehicle to be charged.

In addition, the charging device 10 has an output unit 28 which is coupled to the adapter plug magazine 14 and is set up to release an adapter plug 18 from the adapter plug magazine 14 when the control unit 26 has selected the adapter plug 18.

FIGS. 2 and 3 show various embodiments for the adapter plug magazine 14.

In FIG. 2, the adapter plug magazine 14 is designed as a drum magazine 30. In particular, the adapter plug magazine 14 is designed as a rotating drum magazine 30, which has multiple radially arranged stores 32, wherein each store 32 is occupied by a respective adapter plug 18.

The mode of operation of such an adapter plug magazine 14 embodied as a drum magazine 30 can be described as follows. The drum magazine 30 can rotate about a central axis, wherein the adapter plugs 18 stored in the drum magazine 30 are also moved in a rotating manner. If the charging system of a vehicle to be charged is determined via the communication interface 24, the control unit 26 can control the adapter plug magazine 14 embodied as drum magazine 30 in such a way that the adapter plug magazine 14 rotates until the adapter plug 18 suitable, i.e., compatible, for the charging system of the vehicle can be removed via the output unit 28.

In FIG. 3, the adapter plug magazine 14 is designed as a circulation system 34. Such a circulation system 34 can also be referred to as a paternoster elevator.

The circulation system 34 has a circulating towing connection 36, to which multiple levels 38 are attached. The towing connection 36 can be designed as a towing belt, a towing chain or a towing cable. The plurality of levels 38 is guided by the towing connection 36 in the direction of circulation. The towing connection 36 can be moved in the direction of circulation by at least one drive device 40, as a result of which the levels 38 are also entrained. In the present case, two drive devices 40 are provided.

The stock 16 of the plurality of adapter plugs 18 is provided on the multiple levels 38. In particular, each level 38 is occupied by one adapter plug 18.

The circulation system 34 has a common removal and loading opening (not shown here) for removing and loading the adapter plugs.

The operating principle of such a circulation system can be described as follows. The adapter plugs 18 stored on the levels 38 can be moved in the direction of circulation. If the charging system of a vehicle to be charged is queried via the communication interface 24 and this information is passed on to the control unit 26, which then selects a suitable adapter plug 18 from the stock 16, the circulation system 34 is moved in the direction of circulation until the selected adapter plug 18 reaches the common removal and loading opening and can be removed there via the output unit 28.

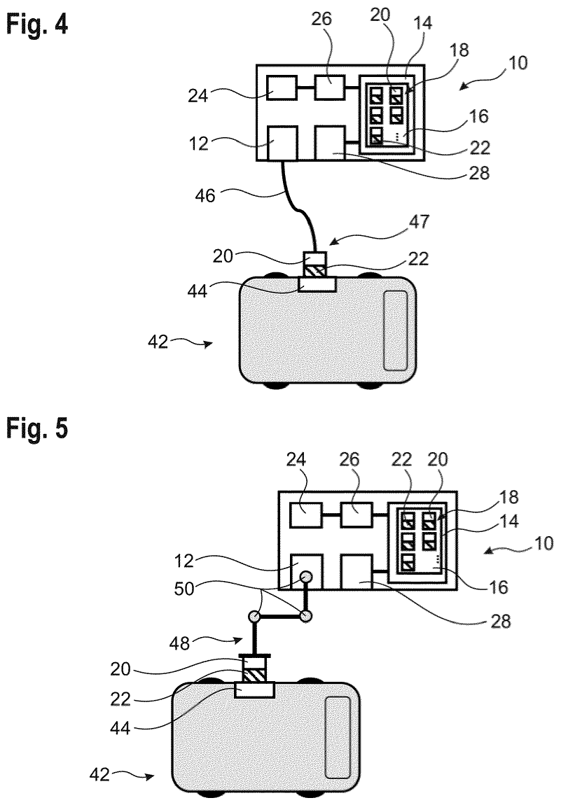

FIG. 4 shows the charging device 10 from FIG. 1, wherein the charging interface 12 is coupled to an electrically powered vehicle 42. The electrically powered vehicle can be a fully electrically powered vehicle or a hybrid vehicle.

More precisely, the charging interface 12 is electrically connected to the vehicle 42 via a charging cable 46. The charging cable 46 can either be part of the charging device 10 or connected to it via a plug/socket connection. The charging cable 46 also has an end 47 on the vehicle side, via which it can be coupled to the vehicle 42. For this purpose, the vehicle-side end 47 of the charging cable 46 is electrically coupled to the first adapter side 20 of an adapter plug 18, wherein the second adapter side 22 of the adapter plug 18 in question is coupled to a charging socket 44 of the vehicle 42.

FIG. 5 shows the same arrangement as already described in FIG. 4, with the difference that a motorized adjustable charging arm 48 is provided instead of a charging cable 46.

The charging arm 48 has a plurality of joints 50 that allow the arm to be adjusted in a motorized manner. In the present case, for example, three joints 50 are provided.

Consequently, the charging device 10 shown is designed as an automatic charging device 10. The motorized adjustable charging arm 48 can be brought into engagement with the output unit 28 and is set up to couple with the first adapter side 20 of the adapter plug 18 after an adapter plug 18 has been selected by the control unit 26 and to effect an automatic transfer of the adapter plug 18 from the output unit 28 into the charging socket 44 of the vehicle 42 to be charged, so that the vehicle 42 can be electrically coupled to the charging arm 48 and charged via the second adapter side 22 of the adapter plug 18.

A charging process with a charging device 10 is described below by way of example, which is not to be interpreted in a restrictive sense.

An electrically driven vehicle 42 to be charged approaches the charging device 10. First, charging-system-specific data about the vehicle 42 to be charged is queried via the communication interface 24 and forwarded to the control unit 26. The vehicle 42 is thus identified by the charging device 10, wherein in particular the charging system of the vehicle 42 is queried by the communication interface 24.

Using the information determined by the communication interface 24, the control unit 26 selects an adapter plug 18 compatible with the vehicle 42 from the adapter plug magazine 14, wherein the second adapter side 22 of the selected adapter plug 18 is compatible with the charging system of the electrically driven vehicle 42. The adapter plug 18 can be released via the output unit 28.

Thereafter, the adapter plug 18 can either be manually removed from the output unit 28 by a user, plugged with the first adapter side 20 onto the vehicle-side end 47 of a charging cable 46 and then coupled to the charging socket 44 of the vehicle 42 via the second adapter side 22 or, a motorized adjustable charging arm 48 can remove the adapter plug 18 from the output unit 28 and connect to the charging socket 44 of the vehicle 42 via the adapter plug.

In both cases, the charging device 10 is sequentially coupled to the vehicle 42 via the charging interface 12, optionally a charging cable 46 or a charging arm 48, the adapter plug 18 and the charging socket 44. After successful coupling, the charging process can begin.

1.-10. (canceled)

11. A charging device for charging electrically driven vehicles carrying loads and/or people, comprising:
a charging interface for coupling the charging device to a charging socket of an electrically driven vehicle;
a communication interface for identifying the vehicle;
an adapter plug magazine, which contains a stock of a plurality of adapter plugs; and
a control unit, which is connected in an information-exchanging manner to the communication interface and the adapter plug magazine and is configured to control the adapter plug magazine,
wherein each of the plurality of adapter plugs has a first adapter side which is compatible with the charging interface of the charging device and a second adapter side which is compatible with a specific charging system for an electrically powered vehicle, and
wherein each of the plurality of adapter plugs has a second adapter side which is different from the other adapter plugs.

12. The charging device according to claim 11, wherein
the communication interface is configured to query charging-system-specific data about a vehicle to be charged and to forward the charging-system-specific data to the control unit, and
the control unit is configured, based on the data, to select an adapter plug on a second adapter side from the adapter plug magazine, which is compatible with the charging system of the vehicle to be charged.

13. The charging device according to claim 12, wherein
the adapter plug magazine is coupled to an output unit configured to release an adapter plug from the adapter plug magazine when the control unit has selected the adapter plug.

14. The charging device according to claim 13, wherein
the charging device is an automatic charging device and has a motorized adjustable charging arm which is movable into engagement with the output unit and is configured, after the selection of an adapter plug by the control unit, to couple with the first adapter side of the adapter plug and to effect an automatic transfer of the adapter plug from the output unit into the charging socket of the vehicle to be charged, whereby the vehicle is electrically couplable to the charging arm and charged via the second adapter side of the adapter plug.

15. The charging device according to claim 13, wherein
the output unit is configured to make the adapter plug selected by the control unit available to a user, so that the user can electrically couple the vehicle to be charged to the charging interface of the charging device via the adapter plug.

16. The charging device according to claim 11, wherein
the communication interface is designed as a touch display, a WLAN interface, an NFC interface or a Bluetooth interface.

17. The charging device according to claim 11, wherein
the second adapter side of an adapter plug corresponds to a charging system selected from the group consisting of: Type-1, Type-2 Mennekes, CCS, Type-F, CEE, ChadeMo and Tesla Supercharger, as well as manufacturer-specific features thereof.

18. The charging device according to claim 11, wherein
the charging device is a stationary charging device.

19. The charging device according to claim 11, wherein
the charging device is a stationary charging column.

20. The charging device according to claim 11, wherein
the adapter plug magazine is a rotating drum magazine which has multiple radially arranged stores, wherein each store is occupied by one adapter plug of the plurality of adapter plugs.

21. The charging device according to claim 11, wherein
the adapter plug magazine is a circulation system which has multiple levels that rotate about a central axis,
each level is occupied by one adapter plug of the plurality of adapter plugs, and
the circulation system has a common removal and loading opening for removing and loading the adapter plugs.
